(19) United States
(12) Patent Application Publication
(10) Pub. No.: US 2014/0143273 A1
(43) Pub. Date: May 22, 2014

(54) INFORMATION-PROCESSING DEVICE, STORAGE MEDIUM, INFORMATION-PROCESSING SYSTEM, AND INFORMATION-PROCESSING METHOD

(71) Applicants: Masamichi SAKAINO, Kyoto (JP); Hisatoshi TAKEUCHI, Tokyo (JP); Zenta ANDOH, Tokyo (JP)

(72) Inventors: Masamichi SAKAINO, Kyoto (JP); Hisatoshi TAKEUCHI, Tokyo (JP); Zenta ANDOH, Tokyo (JP)

(73) Assignees: HAL LABORATORY, INC., Tokyo (JP); NINTENDO CO., LTD., Kyoto-shi (JP)

(21) Appl. No.: 14/081,952

(22) Filed: Nov. 15, 2013

(30) Foreign Application Priority Data
Nov. 16, 2012 (JP) 2012-252421

(51) Int. Cl. G06F 17/30

(52) U.S. Cl. CPC G06F 17/30545
USPC 707/770

(57) ABSTRACT

An exemplary information-processing device includes: a first accessing unit configured to access a first database storing data sets, each of the data sets relating to values of attribute items; a second accessing unit configured to access a second database storing a group of keywords including at least one keyword, an attribute item corresponding to the group of keywords, and a value of the attribute item corresponding to the group of keywords; and an extracting unit configured, when a keyword input for a search is included in the second database, to extract from the first database, as a result of the search, at least one data set relating to the value corresponding to the input keyword of the attribute item corresponding to the input keyword.

### CROSS REFERENCES TO RELATED APPLICATIONS

The disclosure of Japanese Patent Application No. 2012-252421, filed on Nov. 16, 2012, is incorporated herein by reference.

### FIELD

This application describes information searching.

### BACKGROUND AND SUMMARY

Electronic books i.e. printed books that are digitalized and stored in an electric storage medium to be browsed via an information terminal, have been developed. Printed books to be digitalized as electronic books include dictionaries, textbooks, and/or teaching materials, and so on, in addition to any other books. The digitalized text data of books can be displayed on a display screen. For example, an information-searching device having a tablet-type display for searching information from an electronic dictionary, the electronic dictionary being digitalized and stored in an electric storage medium, is known.

The present disclosure enables provision of a variety of search results to a user.

There is provided an information-processing device including: a first accessing unit configured to access a first database storing data sets, each of the data sets relating to values of attribute items; a second accessing unit configured to access a second database storing a group of keywords including at least one keyword, an attribute item corresponding to the group of keywords, and a value of the attribute item corresponding to the group of keywords; and an extracting unit configured, when a keyword input for a search is included in the second database, to extract from the first database, as a result of the search, at least one data set relating to the value corresponding to the input keyword of the attribute item corresponding to the input keyword.

### BRIEF DESCRIPTION OF THE DRAWINGS

Exemplary embodiments will be described with reference to the following drawings, wherein:

FIG. 1 shows an example of a non-limiting configuration of database 111;

FIG. 2 shows an example of a non-limiting user interface 92 for conducting a search according to a comparative example;

FIG. 3 shows an example of a non-limiting user interface 91 for conducting a search according to an exemplary embodiment;

FIG. 4 shows an example of a non-limiting functional configuration of information-processing system 1 according to an exemplary embodiment;

FIG. 5 shows an example of a non-limiting hardware configuration of information-processing system 1;

FIG. 6 shows an example of a non-limiting flowchart illustrating an operation of information-processing system 1;

FIG. 7 shows an example of a non-limiting user interface 50;

FIG. 8 shows an example of non-limiting data stored in keyword database 112; and

FIG. 9 shows an example of a non-limiting screen showing a search result.

### DETAILED DESCRIPTION OF NON-LIMITING EXEMPLARY EMBODIMENTS

### Summary

The present embodiment relates to a search of data sets. In the present embodiment, a group of data sets that is a searched object is stored in a database. This database includes a plurality of data sets. Each of the plurality of data sets included in the database includes one or more attribute items, also referred to as “categories,” “items,” or “labels,” hereinafter; and stores a value of each of the one or more attribute items with respect to each data set. In this search system, when a keyword for a search (hereinafter, referred to as a “search key”) is input, data sets including the search key in one or more specific attribute items are usually extracted as a search result from the database. However, when a specific keyword is input as a search key, data sets including the search key in one or more attribute items other than the specific attribute items are extracted as a search result. Each data set in the database is composed of, for example, a group of values of attribute items.

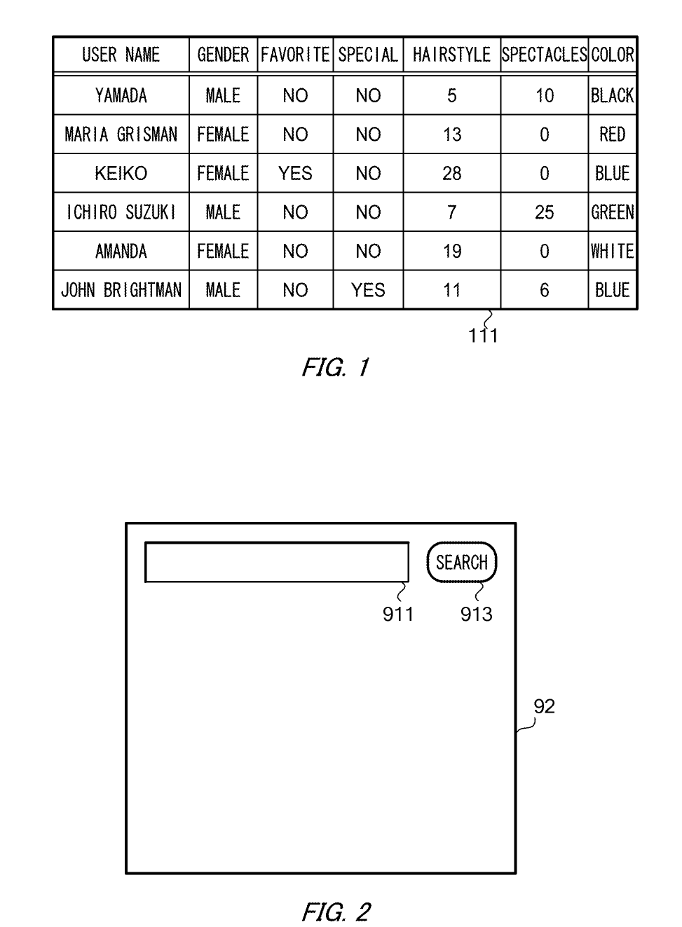

FIG. 1 shows an example of a non-limiting configuration of database 111 including a group of data sets that is a searched object. In this example, the group of data sets being the searched object includes data sets of user images used in a service (so-called avatar images.) This service is used by a plurality of users. Each user can devise his/her user image. The user image is a representation of a whole body image of a human, and has a plurality of attribute items. The different kinds and a number of the attribute items are predetermined, and all of the data sets stored in database 111 have in common the predetermined attribute items.

The plurality of attribute items of a user image includes, for example, attribute items such as “user name,” “gender,” “favorite,” “special,” “hairstyle,” “spectacles,” and “color.” The attribute item “user name” represents a name of a user who uses the user image. The attribute item “gender” indicates the gender of the user, and, in this example, the attribute item has either a value of “male” or “female.” The attribute item “favorite” indicates whether the user of database 111 stores the user image as a favorite. In this example, the attribute item “favorite” has either a value of “YES” or “NO.” Namely, in this example, database 111 is established with respect to each user, and each database 111 is used by a user for whom the database 111 is established. The attribute item “special” indicates whether the user image is a specific user image being predetermined in the system. In this example, the attribute item “special” has a value of “YES” or “NO.” The attribute item “hairstyle” indicates a hairstyle used in the user image. In this example, the attribute item “hairstyle” has a value of any natural number from zero to thirty-one. In this system, thirty-two images of hairstyles that can be used as a part of a user image are provided, and a natural number from zero to thirty-one is assigned to each of the images as its identification number. The attribute item “spectacles” indicates spectacles that are used as a part of the user image, and, in this example, the attribute item “spectacles” has a value of any natural number from zero to thirty-one. It is to be noted that the attribute item “spectacles” whose value is “zero” indicates that the user image includes no image of spectacles. In this system, thirty-one images of spectacles that can be used as a part of a user image are provided, and a natural number from zero to thirty-one is assigned to each of the images as its identification number. A value of the attribute item “spectacles” is an identification number assigned to an image of spectacles when the user image includes the image of spectacles. The attribute item “color” indicates a color of clothes that is a part of the user image, and, in this example, the attribute item “color” has any one of the values of “red,” “blue,” “yellow,” “green,” “black,” and “white.” Values of attribute items other than the attribute item “user name” are selected by the user from among predetermined options.

It is to be noted that each of the attribute items in database 111 has a binary data set whose number of bits corresponds to a number of predetermined options for the attribute item with respect to each attribute item whose value is selected from among predetermined options (i.e., the attribute items “gender,” “favorite,” “special,” “hairstyle,” “spectacles,” and “color, in the example shown in FIG. 1”). For example, regarding the attribute item “color,” a binary data set having three bits is stored in database 111 since the attribute item “color” has five options. Although a binary data set of three bits is stored in database 111 with regard to the attribute item “color,” in order to facilitate understanding, names of the five optional colors are listed in FIG. 1.

FIG. 2 shows an example of a non-limiting user interface 92 for conducting a search according to one exemplary embodiment. In this example, user interface 92 includes search window 911 and button 913. Search window 911 is a region for inputting a search key. Button 913 is a button for instructing execution of the search. In this system, the search is carried out using the attribute item “user name” as a general rule. However, in a case when button 913 is touched after a search key “Yamada” is input to search window 911, data sets of user images whose attribute item “user name” has a value that is indicated by text including the name “Yamada” are extracted as a search result. However, in this example, the search is carried out using attribute items other than “user name” if a predetermined specific text (hereinafter, referred to as “a specific keyword”) is input to search window 911. For example, if button 913 is touched after a search key “man” which is a specific keyword, is input to search window 911, data sets of user images whose attribute item “gender” has a value of “male” are extracted in addition to data sets of user images whose attribute item “user name” has a value indicated by text including the word “man” as a search result. A system providing the above-mentioned search is described in section 2 of the present specification.

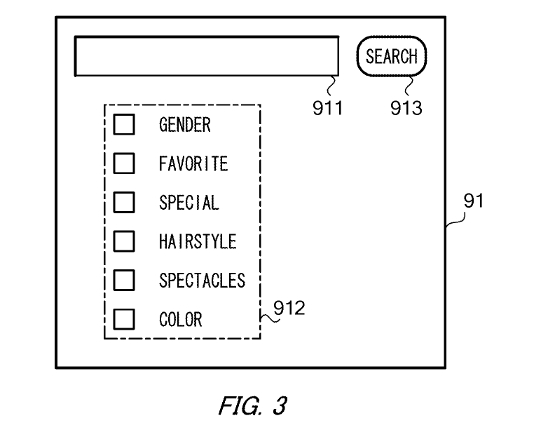

FIG. 3 shows an example of a non-limiting user interface 91 for conducting a search according to another exemplary embodiment. In this example, user interface 91 is an image displayed by a display device, and includes search window 911, group of checkboxes 912 and button 913. A group of checkboxes 912 is a group of objects, which specify an attribute item whose values should be compared with a search key. In this system, the search is carried out using the attribute item “user name” as a general rule. For example, if button 913 is touched after a search key “red” is input to search window 911 and none of the checkboxes in a group of checkboxes 912 are checked user images, a value of the attribute item “user name” indicated by text including the word “red,” is extracted as a search result. A group of checkboxes 912 is used in a case when a user wants to add or change attribute items that should be searched. For example, if button 913 is touched after a search key “red” is input to search window 911 and a checkbox corresponding to the attribute item “color” in the group of check boxes 912 is checked, data sets of user images whose attribute item “color” is “red,” i.e. data sets including user images wearing red clothes, are extracted, in addition to data sets whose attribute item “user name” has a value indicated by text including the word “red” as a search result.

### Configuration

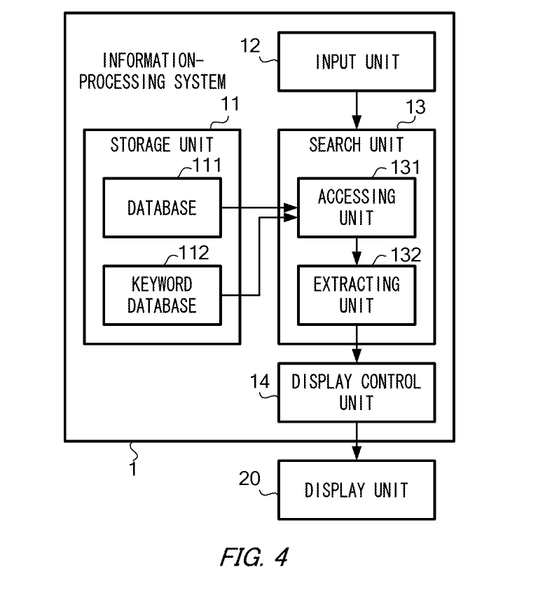

FIG. 4 shows an example of a non-limiting functional configuration of information-processing system 1 according to an exemplary embodiment. Information-processing system 1 includes storage unit 11, input unit 12, search unit 13, and display control unit 14. Storage unit 11 stores database 111 and keyword database 112. Database 111 is a database that stores a group of data sets that are searched objects as explained above with reference to FIG. 1. Keyword database 112 is a database that stores information about specific keywords. Specifically, keyword database 112 includes a group of keywords including at least one keyword, an attribute item corresponding to the group of keywords (an attribute item of a user image) and a value of the attribute item. Input unit 12 inputs a search key for search unit 13. Search unit 13 conducts a search using the input search key. Search unit 13 has accessing unit 131 and extracting unit 132. Accessing unit 131 accesses database 111 and keyword database 112. If a search key input from input unit 12 is stored in keyword database 112 as a specific keyword, extracting unit 132 specifies an attribute item and a value of the attribute item corresponding to the specific keyword in keyword database 112, and extracts from database 111 data sets including the specified value in the specified attribute item as a search result. Display control unit 14 causes display unit 20 to display an image indicating the search result. Display unit 20 displays information indicated by at least one of a text and an image.

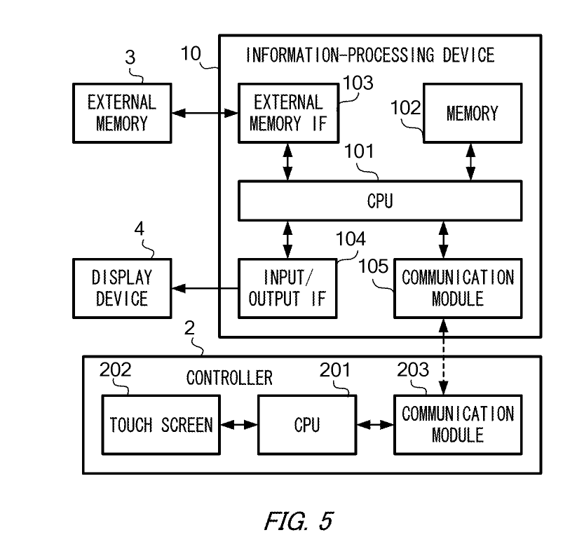

FIG. 5 shows an example of a non-limiting hardware configuration of information-processing system 1 according to an exemplary embodiment. In this example, information-processing system 1 has information-processing device 10 and its peripheral devices. In this example, information-processing device 10 is a game device for playing a video game. Information-processing device 10 is a computer device including CPU (Central Processing Unit) 101, memory 102, external memory IF 103, input/output IF 104 and communication module 105. Controller 2 is used by a user for operating information-processing device 10. Information-processing device 10 is connected to display device 4. Display device 4 is a device for displaying at least one of an image and a text, and includes a display (for example, liquid crystal panel, organic electro-luminescence display panel, and so on) and a drive circuit thereof. In this example, information-processing device 10 is a so-called console type game device that does not include display device 50. Display device 4 is an external device, such as a television set. It is to be noted that information-processing device 10 may include display device 4.

CPU 101 is a device for controlling the elements of information-processing device 10 other than CPU 101, and executes various calculations. Memory 102 is a storage device for storing programs and any other sorts of data sets, and has, for example, a RAM (Random Access Memory) and/or a ROM (Read Only Memory). External memory IF 103 is an interface for reading/writing a program and/or any other sort of data set from/into external memory 3 (for example, an optical disk, a magnetic disk, or a semiconductor memory) that stores programs (for example, a game program) and/or other sort of data sets. Input/Output IF 104 is an interface for mediating signals between input/output device (in this example, display device 4) and CPU 101. Communication module 105 is a device for communicating with controller 2, and includes, for example, an antenna and/or an amplifier. When a program (for example, a video game) stored in external memory 3 or memory 102 is executed by information-processing device 10, a function of the program is realized in information-processing device 10.

Controller 2 is a device for inputting instructions to information-processing device 10. In this example, controller 2 further has a function to display an image according to signals transmitted from information-processing device 10. Controller 2 includes CPU 201, touch screen 202, and communication module 203. CPU 201 is a device for controlling elements of controller 2 other than CPU 201, and executes various calculations using a memory (not shown in FIG. 5.) Touch screen 202 is a device that provides both of a function to display information and a function to input instructions, and includes, for example, a display panel, a drive circuit and touch sensors provided on a surface of the display panel. Communication module 203 is a device for communicating with information-processing device 10, and includes, for example, an antenna and an amplifier.

In this example, a function for searching user images is provided by programs stored in external memory 3 or memory 102 (a game program, a system software, and/or a combination thereof). In the following descriptions, a program that provides the function for searching user images is referred to as “a search program.” CPU 101 executing the search program functions as input unit 12, search unit 13, and display control unit 14. Memory 102 functions as storage unit 11; and stores database 111 and keyword database 112. Display device 4 functions as display unit 20.

### Operation

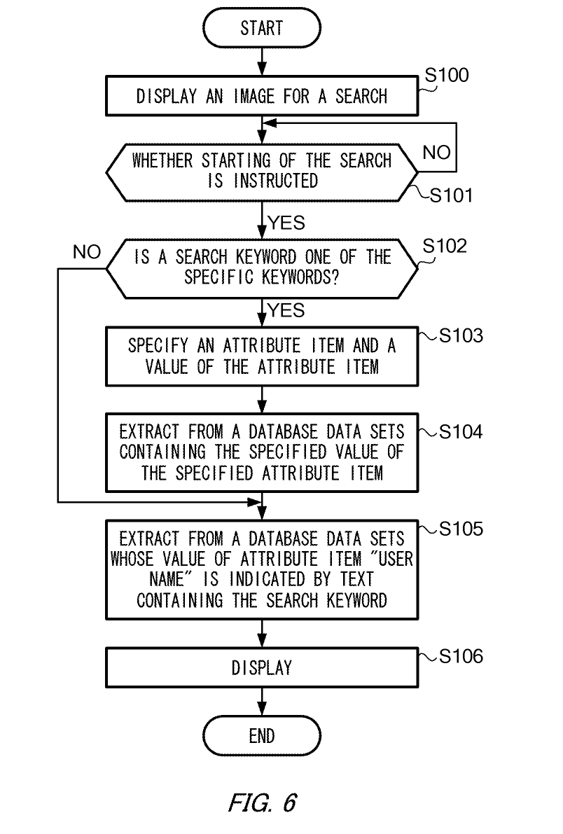

FIG. 6 shows an example of a non-limiting flowchart illustrating operations of information-processing system 1 according to an exemplary embodiment. The flow shown in FIG. 6, for example, is started when an execution of the search program is started, and is implemented in accordance with the search program. In step S100, CPU 101 causes display device 4 to display an image of a user interface for the search.

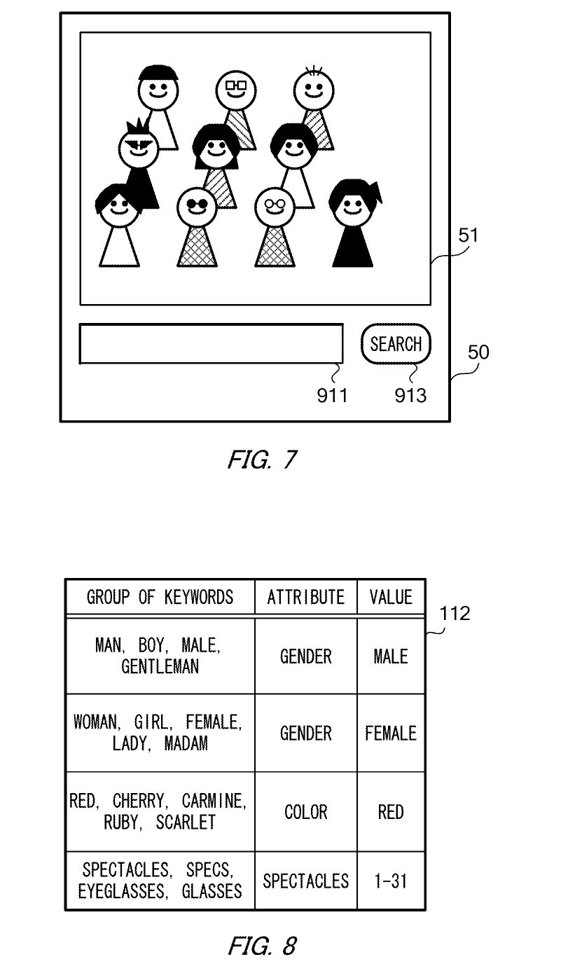

FIG. 7 shows an example of a non-limiting user interface 50 used in an exemplary embodiment. User interface 50 includes window 51, search window 911, and button 913. Window 51 is a region for displaying at least one of the user images included in data sets stored in database 111. In this example, ten user images selected according to a predetermined rule (for example, ten user images included in the top ten data sets in the order of their registration in database 111) are displayed in window 51. A user of information-processing system 1 can input a search key in user interface 50.

Referring to FIG. 6 again, in step S101, CPU 101 determines whether starting of the search is instructed. The starting of the search is instructed by button 913 being touched. When it is determined that the starting of the search is instructed (step S101: YES), CPU 101 executes step S102. When it is determined that the starting of the search is not instructed (step S101: NO), CPU 101 waits until the start of the search is instructed.

In step S102, CPU 101 determines whether the search key is a specific keyword by referring to keyword database 112. When it is determined that the search key is a specific keyword (step S102: YES), CPU 101 executes step S103. When it is determined that the search key is not a specific keyword (step S102: NO), CPU 101 executes step S105.

FIG. 8 shows an example of non-limiting data stored in keyword database 112. Keyword database 112 stores data sets, each of which includes a group of keywords, an attribute item corresponding to the group of keywords, and a value of the attribute item. In this example, the value of the attribute item corresponding to the group of the keywords is selected from among predetermined options. In other words, in the example shown in FIG. 1, the attribute item corresponding to the groups of keywords is one of the attribute items of database 111 other than the attribute item “user name.” Values of the attribute items are stored as binary data sets; although to facilitate understanding, the values of attribute items can be indicated by text, as described in FIG. 8. A group of keywords includes at least one keyword. In this example, each group of keywords consists of synonyms of a word. For example, a data set in the top line of the list shown in FIG. 8 shows that the attribute item “gender” and the value “male” are stored in correspondence with a group of keywords including a keyword “man” and its synonyms, i.e. “boy,” “male,” and “gentleman”. A data set in the third line of the list shown in FIG. 8 shows that the attribute item “color” and the value “red” are stored in correspondence with a group of keywords including a keyword “red” and its synonyms, i.e. “cherry,” “carmine,” “ruby,” and “scarlet.” A data set in the fourth line of the list shown in FIG. 8 shows that the attribute item “spectacles” and natural numbers from zero to thirty-one are stored in correspondence with a group of keywords including the keyword, “spectacles” and its synonyms, i.e. “specs,” “eyeglasses,” and “glasses.” As shown in the last example of data sets in keyword database 112, a data set in keyword database 112 may include a plurality of values of attribute items corresponding to a group of keywords. Further, a data set in keyword database 112 may include a plurality of attribute items corresponding to a group of keywords.

In this example, CPU 101 compares the search key with each of the keywords included in the group of the keywords. CPU 101 determines that the search key is a specific keyword when the search key is stored in the category “group of keywords” of any one of data sets stored in keyword database 112. On the other hand, CPU 101 determines that the search key is not a specific keyword when the search key is not stored in the category “group of keywords” of any one of data sets in keyword database 112. In this example, if the search key is, for example, “man,” it is determined that the search key is a specific keyword. On the other hand, if the search key is, for example, “Yamada,” it is determined that the search key is not a specific keyword.

Referring to FIG. 6 again, in step S103, CPU 101 accesses keyword database 112, and specifies an attribute item and a value of the attribute item corresponding to the search key. For example, when the search key is “man,” the attribute item “gender” and the value of the attribute item “male” are specified. CPU 101 stores the specified attribute item and the specified value of the attribute item in memory 102.

In step S104, CPU 101 accesses database 111, and extracts data sets including the value specified in step S103 in the attribute item specified in step S103 as a search result. For example, when the search key is “man,” “gender” is specified as the attribute item in step S103 and “male” is specified as the value of the attribute item in step S103 in accordance with the example shown in FIG. 8. Accordingly, CPU 101 accesses database 111 and extracts data sets that include the value “male” in the attribute item “gender” as the search result. In accordance with the example shown in FIG. 1, three data sets whose values of the attribute item “user name,” indicated by text as in “Yamada,” “Ichiro Suzuki,” and “John Brightman,” are extracted. CPU 101 stores the extracted data sets in memory 102. The search result means data sets extracted by the search, and in this example, the search result is stored in memory 102.

In step S105, CPU 101 accesses database 111, and extracts data sets including the search key in the attribute item “user name” as the search result. When the search key is “man,” two data sets, whose values of the attribute item “user name” that are indicated by texts as in “Maria Grisman” and “John Brightman,” are extracted, in accordance with the example shown in FIG. 1. CPU 101 stores the extracted data sets in memory 102.

In step S106, CPU 101 causes display device 4 to display an image indicating the search result.

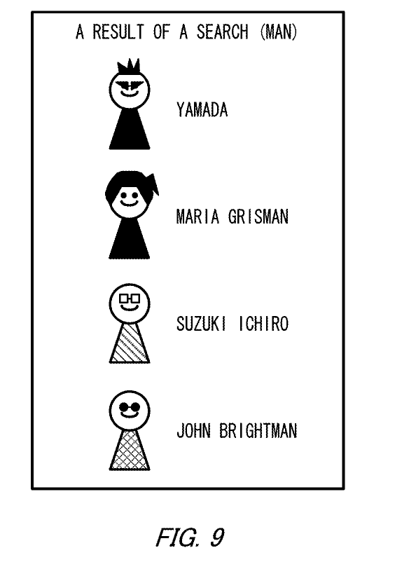

FIG. 9 shows an example of a non-limiting screen showing the search result. In this example, four data sets whose attribute item “user name” indicates “Yamada,” “Maria Grisman,” “Ichiro Suzuki” or “John Brightman,” are extracted as the search result, and displayed in an order determined by a predetermined rule (for example, in an order in which they are stored in database 111.) According to the present embodiment, as described above, various search results are provided to the user. It is to be noted that, in this example, data sets extracted in step S104 and data sets extracted in step S105 are not displayed in a manner in which they can be distinguished from each other. However, data sets extracted in step S104 and data sets extracted in step S105 may be displayed in a manner in which they can be distinguished from each other visually. For example, a method where different background colors are used or any one of the search results is identified by marking may be employed for distinguishing a data set visually.

### Modification

The present disclosure should not be limited by the embodiments described above. Various modifications can be applied to the exemplary embodiments. Some modifications will be described below. Two or more modifications from among the following modifications may be combined.

Values of attribute items stored in correspondence with groups of keywords in keyword database 112 are not limited to the values selected from among predetermined options. Further, FIG. 1 is just an example, and attribute items of data sets stored in database 111 are not limited to the attribute items shown in FIG. 1. For example, data sets stored in database 111 may not include the attribute item “user name.” In another example, all attribute items of data sets stored in database 111 may include values selected from among predetermined options. Further, attribute items of data sets stored in one database 111 that is established for a particular user may be different from those of another database 111 established for another user.

In the present modification database 111 is not limited to a database used by a single user, namely a database being unique to a specific user. A database may be shared by a plurality of users. In such a case, a server on a network may include a storage unit storing the database.

In a case when values of attribute items in database 111 are selected from among predetermined options, the selection is not limited to a selection made by a user. Values may be automatically selected from among the options by the system and stored in correspondence with attribute items of database 111.

In a case when values of attribute items in database 111 and/or keyword database 112 are selected from among predetermined options, the values may be stored in database 111 and/or keyword database 112 as text data sets, instead of binary data sets.

Keyword database 112 may be provided with respect to each of a plurality of different languages. For example, in a case when four languages (for example, English, French, German, and Japanese) are available in information-processing system 1, keyword database 112 includes four subsets, each of the subsets corresponding to each language set, namely, keyword database 112 of the English edition, keyword database 112 of the French edition, keyword database 112 of the German edition, and keyword database 112 of the Japanese edition. Accordingly, information-processing system 1 uses one of the four subsets in keyword data 112, corresponding to a language preferred by a user. The language of the user, which is specified at the time of user registration, may be changed by an instruction input by the user, for example, by touching a button for changing a language; and such an instruction may be input by the user at any time.

A configuration of keyword database 112 is not limited to the example shown in FIG. 8. For example, keyword database 112 may include only groups of keywords and values of attribute items corresponding to the groups of keywords, and may not include attribute items (categories, items, or labels) corresponding to the groups of keywords. In such a case, only a value corresponding to a search key is identified in step S103, and data sets including the identified value are extracted in step S103. For example, if the search key is “man,” “male” is specified as a value of the attribute item in step S103 in accordance with the example shown in FIG. 8. CPU 101 accesses database 111 and searches data sets including the value “male” in any one of their attribute items.

In the above embodiment, one attribute item is treated as a searched object with respect to each group of keywords. However, two or more attribute items may be treated as searched objects. In other words, a search may be carried out in connection with two or more attribute items by use of one search key. In such a case, storage unit 11 may store a third database in addition to database 111 and keyword database 112. The third database may include data sets, each of which includes two or more pairs of an attribute item and a value of the attribute item corresponding to a specific keyword. For example, the third database may include a data set corresponding to a keyword “stylish” indicating a pair of an attribute item “hairstyle” and a specific value of the attribute item “hairstyle,” and another pair of an attribute item “color” and a specific value of the attribute item “color.” In such a case, CPU 101 determines whether a search key is included in the third database when the search key is input. CPU 101 extracts data sets that meet conditions of two or more pairs of an attribute item and a value of the attribute item corresponding to the input search key when it is determined that the input search key is included in the third database. For example, when a search key “stylish” is input, CPU 101 extracts from database 111 data sets including both the specific value of hairstyle in the attribute item “hairstyle” and the specific value of color in the attribute item “color” as a search result. In other words, user images including a combination of a specific hairstyle and clothes of a specific color are extracted as the search result.

A user interface used for the search is not limited to the example shown in FIG. 9. Any user interface other than the example shown in FIG. 9, such as the user interface described in FIG. 2 and/or FIG. 3, may be used. In a case when the user interface shown in FIG. 3 is used, attributes specified via this user interface are treated as searched objects, in addition to (or alternatively to) attributes specified by keyword database 112. It is to be noted that keyword database 112 may be omitted when the user interface shown in FIG. 3 is used. In addition, a screen displayed on touch screen 202 may be different from a screen displayed on display device 4. For example, search window 911, button 913 and a software keyboard may be displayed on touch screen 202, and the search result may be displayed in display device 4.

A flow by the search program may be limited to the example shown in FIG. 6. For example, the processing of step S105 may not be carried out when the search key is a specific keyword, and the processing of step S105 may be carried out when the search key is not a specific keyword. In another example, the processing of step S105 may be carried out before the processing of step S104, and the processing of step S104 may not be carried out if the search key corresponds to any one of the user names.

The hardware configuration for implementing the functions described in FIG. 1 is not limited to the example shown in FIG. 5. A device may have any hardware configuration as long as the required functions can be implemented by the device. In addition, information-processing system 1 is not limited to that comprised of information-processing device 10 and the peripheral devices thereof. Information-processing device 1 may include, for example, information-processing device 10 and a server. In such a case, a plurality of functions shown in FIG. 1 may be assigned to either information-processing device 10 or the server. For example, information-processing device 10 may include input unit 12 and display control unit 14, and the server may include storage unit 11 and search unit 13. In addition, the server is not restricted to a single device, and may include a plurality of devices. For example, a device that stores database 111 may be different from a device that stores keyword database 112.

Information-processing device 10 is not limited to a console type game device. Information-processing device 10 may be an information-processing device other than a game device such as a portable game device, a personal computer, a mobile phone, a PDA (Personal Digital Assistants), or a tablet device. Further, an application program executed in information-processing device 10 is not limited to a game application. The application program may be other than the game application, for example, a word processing application, educational application, or any other utility software. Further, some of the functions described as functions of information-processing device 10 may be assigned to a server device on a network. In such a case, an information-processing system including the server device and information-processing device 1 has the functions described in the embodiment. Further, some of the functions described as functions of information-processing device 10 in the embodiment may be omitted.

The application program executed in information-processing device 10 is not limited to an application program that is provided in a storage medium. The application program may be downloaded via a network such as the Internet. Further, the system software of information-processing device 10 may be provided by a storage medium or by downloading from the Internet.

What is claimed is:

1. An information-processing device comprising:
a first accessing unit configured to access a first database storing data sets, each of the data sets relating to values of attribute items;
a second accessing unit configured to access a second database storing a group of keywords including at least one keyword, an attribute item corresponding to the group of keywords, and a value of the attribute item corresponding to the group of keywords; and
an extracting unit configured, when a keyword input for a search is included in the second database, to extract from the first database, as a result of the search, at least one data set relating to the value corresponding to the input keyword of the attribute item corresponding to the input keyword.

2. The information-processing device according to claim 1, wherein one or more of the values of the attribute items included in the data sets stored in the first database are selected from among predetermined options.

3. The information-processing device according to claim 1, wherein
at least one of the values of attribute items included in each data set stored in the first database includes text, and
the extracting unit is further configured to extract from the first database data sets relating to the value indicated by text including the input keyword as a part of the result of the search.

4. The information-processing device according to claim 1, wherein one or more of the values of the attribute items included in the data sets stored in the first database are selected from among predetermined options by a user.

5. The information-processing device according to claim 1, wherein
the second database includes sub-databases corresponds to a plurality of language sets, the language of one of the sub-databases being different from the language of another of the sub-databases, and
one sub-database selected from the sub-databases of a language used by a user is accessed by the second accessing unit.

6. The information-processing device according to claim 1, further comprising:
a third accessing unit configured to access a third database storing a keyword, a first attribute item corresponding to the keyword, a value of the first attribute item, a second attribute item corresponding to the keyword and a value of the second attribute item, wherein
the extracting unit is further configured, when the keyword input for the search is included in the third database, to extract from the first database, as a part of the result of the search, at least one data set relating to the value of the first attribute item corresponding to the input keyword and the value of the second attribute item corresponding to the input keyword.

7. The information-processing device according to claim 1, further comprising:
a user interface providing unit configured to provide a user interface that allows a user to select one or more attribute items from among predetermined attribute items as a searched object, wherein
the extracting unit is further configured to extract from the first database, as the result of the search, at least one data set relating to the value corresponding to the input keyword of any one of the one or more attribute items selected as the search object indicated by text including the input keyword.

8. A computer-readable non-transitory storage device storing a program causing a computer device to execute a process, the process comprising:
accessing a first database storing data sets, each of the data sets relating to values of attribute items;
accessing a second database storing a group of keywords including at least one keyword, an attribute item corresponding to the group of keywords, and a value of the attribute item corresponding to the group of keywords; and
extracting, when a keyword input for a search is included in the second database, from the first database, as a result of the search, at least one data set relating to the value corresponding to the input keyword of the attribute item corresponding to the input keyword.

9. An information-processing system comprising:
a first accessing unit configured to access a first database storing data sets, each of the data sets relating to values of attribute items;
a second accessing unit configured to access a second database storing a group of keywords including at least one keyword, an attribute item corresponding to the group of keywords, and a value of the attribute item corresponding to the group of keywords; and
an extracting unit configured, when a keyword input for a search is included in the second database, to extract from the first database, as a result of the search, at least one data set relating to the value corresponding to the input keyword of the attribute item corresponding to the input keyword.

10. An information-processing method comprising:
accessing a first database storing data sets, each of the data sets relating to values of attribute items;
accessing a second database storing a group of keywords including at least one keyword, an attribute item corresponding to the group of keywords, and a value of the attribute item corresponding to the group of keywords; and
extracting, when a keyword input for a search is included in the second database, from the first database, as a result of the search, at least one data set relating to the value corresponding to the input keyword of the attribute item corresponding to the input keyword.

11. An information-processing device comprising:
a first accessing unit configured to access a first database storing data sets, each of the data sets including values of attribute items, each of the values being selected from predetermined options;
a second accessing unit configured to access a second database storing a group of keywords including at least one keyword, an attribute item corresponding to the group of keywords, and a value of the attribute item corresponding to the group of keywords; and
an extracting unit configured, when a keyword input for a search is included in the second database, to extract from the first database, as a result of the search, at least one data set relating to the value corresponding to the input keyword of the attribute item corresponding to the input keyword.
